(19) United States
(12) Patent Application Publication
(10) Pub. No.: US 2021/0129856 A1
(43) Pub. Date: May 6, 2021

(54) Autonomous Infrastructure-Based Vehicle Sensor Callibration

(71) Applicant: Robert Bosch GmbH, Stuttgart (DE)

(72) Inventor: Steven Zack, Essex, CT (US)

(21) Appl. No.: 16/674,311

(22) Filed: Nov. 5, 2019

(51) Int. Cl. B60W 50/04; G07C 5/00; G07C 5/08

(52) U.S. Cl. CPC B60W 50/045; B60W 2050/0083; G07C 5/085; G07C 5/008

(57) ABSTRACT

An infrastructure-based system for assessing the calibration of one or more vehicle sensors in situ, during other routine operations of the vehicle. The calibration assessment system may comprise configurable components useful to adapt the assessment operation to specifications of different makes and models of vehicles or different sensor arrangements. The calibration assessment system may comprise one or more autonomous functions to automatically perform the assessment operation with minimal user involvement.

### TECHNICAL FIELD

This disclosure relates to calibration of vehicle sensors, and in particular vehicle sensors that are utilized for an autonomous function of the vehicle.

### BACKGROUND

Vehicle driving or other functions may utilize one or more vehicle sensors. Sensors may require calibration in response to repairs or maintenance operations. Sensor calibration often requires specialized equipment in highly-controlled environments, and may prove costly and time-consuming for users of the vehicle.

Vehicles having an autonomous function in particular rely heavily upon sensors for safe and effective operation. Ensuring regularly that the sensors are properly calibrated is desirable for optimizing operational efficiency and safety of the vehicle. Regular calibrations and calibration assessments may currently require time-intensive and costly operations in specialized conditions. These costs and loss of usable operation time are increased as more vehicles utilize sensors to accomplish more functions during normal operation.

### SUMMARY

One aspect of this disclosure is directed to a method of assessing the calibration of a sensor of a vehicle, the method comprising an initiation phase, a measurement phase, and a completion phase. The initiation phase may comprise the transfer of initiation signals between the vehicle and system indicating that both the system and vehicle are properly prepared for the assessment, including identification of the vehicle specification by the system. The measurement phase may comprise a number of calibration measurements made with respect to a configurable calibration device to generate calibration-status data indicating the operating calibration of the number of sensors. The completion phase may comprise generating calibration-assessment data indicating the calibration status of the number of sensors under assessment in response to an analysis of the calibration-status data. In some embodiments, the measurement phase may be iteratively completed with different configurations of the calibration device, according to the specified requirements of the sensor.

Another aspect of this disclosure is directed to a calibration assessment system operable to assess the calibration-status of a sensor associated with a vehicle. The calibration assessment system may comprise a processor, a system transmitter operable to transmit data to the vehicle, a system receiver operable to receive data from the vehicle, a calibration device having an autonomously-adjustable configuration, and an initiation-signal generator operable to generate and transmit an initiation signal to initiate an assessment procedure when it is determined that the vehicle and calibration device have a particular relative position with respect to each other.

The above aspects of this disclosure and other aspects will be explained in greater detail below with reference to the attached drawings.

### BRIEF DESCRIPTION OF THE DRAWINGS

FIG. 1 is a diagrammatic illustration of vehicle having a sensor.

FIG. 2 is a diagrammatic illustration of a calibration assessment system during an assessment of a vehicle.

FIG. 3 is an illustration of a calibration device suitable for a calibration assessment system.

FIG. 4 is a flowchart illustrating a method of calibration assessment.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

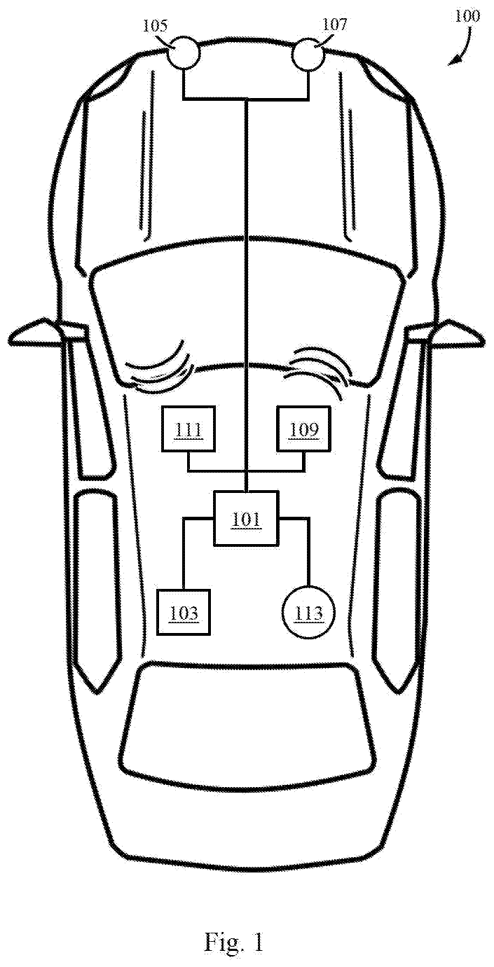

FIG. 1 shows a vehicle 100 having a vehicle processor 101 and a vehicle memory 103. Vehicle memory 103 may comprise computer-readable instructions stored thereon that, when read by vehicle processor 101, cause vehicle processor 101 to execute one or more functions. In the depicted embodiment, vehicle memory 103 may also store vehicle identification information, such as a vehicle identification number (VIN), or other information such as the make, model, and year of the vehicle. Vehicle memory 103 may store additional information without deviating from the teachings disclosed herein.

Computer-readable instructions may include instructions and data which cause a general purpose computer, special purpose computer, or special purpose processing device to perform a certain function or group of functions. Computer-readable instructions may also include program modules that are executed by computers in stand-alone or network environments. Program modules may include routines, programs, objects, components, or data structures that perform particular tasks or implement particular abstract data types. Computer-readable instructions, associated data structures, and program modules represent examples of the program code means for executing steps of the methods disclosed herein. The particular sequence of such executable instructions or associated data structures represents examples of corresponding acts for implementing the functions described in such steps.

Vehicle memory 103 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Vehicle 100 further comprises a number of sensors. In the depicted embodiment, vehicle 100 comprises a first sensor 105 and a second sensor 107, but other embodiments may comprise other configurations without deviating from the teachings disclosed herein. In the depicted embodiment, first sensor 105 and second sensor 107 may be utilized to support an autonomous function of vehicle 100, but other embodiments may comprise other configurations without deviating from the teachings disclosed herein. In such embodiments, first sensor 105 or second sensor 107 may comprise one of a radar sensor, lidar sensor, ultraviolet sensor, camera sensor, ultrasonic sensor, proximity sensor, vibration sensor, lane-position sensor, temperature sensor, emissions sensor, or any other sensor known to one of ordinary skill in the art without deviating from the teachings disclosed herein. Some embodiments may comprise a different configuration or number of sensors without deviating from the teachings disclosed herein. In the depicted embodiment, the sensors are each arranged as front-mounted sensors of vehicle 100, but other embodiments may comprise other or additional positions with respect to the vehicle without deviating from the teachings disclosed herein.

Vehicle 100 also comprises a vehicle transmitter 109 and a vehicle receiver 111, each in data communication with vehicle processor 101 and operable to respectively wirelessly transmit and receive signals from devices or systems external to vehicle 100. In some embodiments, vehicle transmitter 109 and vehicle receiver 111 may be embodied as a single transceiver without deviating from the teachings disclosed herein. Vehicle transmitter 109 and vehicle receiver 111 may be configured to communicate wirelessly via one or more of an RF (radio frequency) specification, cellular phone channels (analog or digital), cellular data channels, Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

In the depicted embodiment, vehicle 100 also comprises a geolocation sensor 113. Geolocation sensor 113 may be operable to detect a location of vehicle 100 utilizing an external positioning system, such as global positioning system (GPS), a different global navigation satellite system (GNSS), or other positioning system recognized by one of ordinary skill in the art. Geolocation sensor 113 may be operable to generate geolocation data describing the location of vehicle 100 with respect to the surrounding environment.

In the depicted embodiment, vehicle 100 comprises a privately-owned sedan, but other embodiments may comprise other configurations without deviating from the teachings disclosed herein. By way of example, and not limitation, vehicle 100 may comprise a truck, compact car, sports car, luxury vehicle, van, minivan, motorcycle, limousine, taxi, private fleet vehicle, commercial fleet vehicle, commercial shipping vehicle, or any other suitable vehicle without deviating from the teachings disclosed herein.

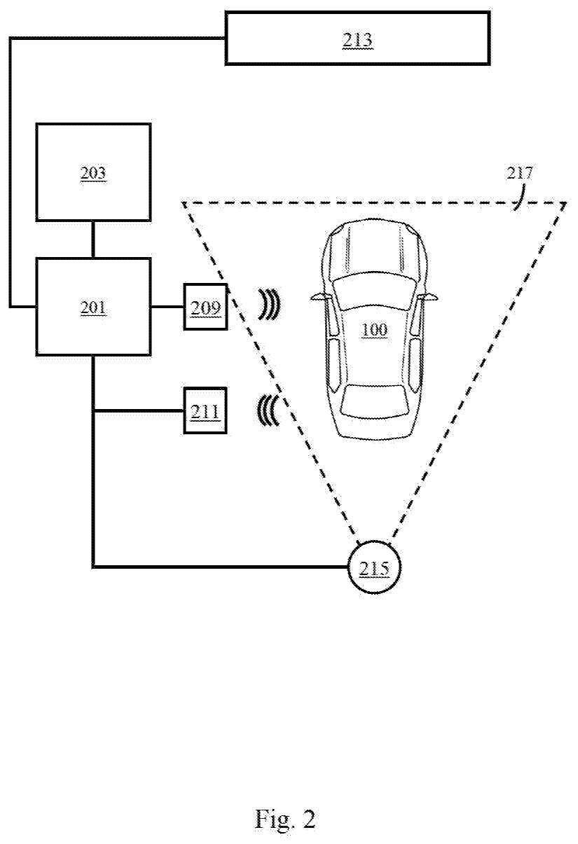

FIG. 2 is a diagrammatic illustration of a calibration assessment system suitable for assessing the calibration of a sensor of a vehicle. In the depicted environment, the system may be suitable for assessing the calibration of sensor utilized for an autonomous function of a vehicle, but other embodiments may comprise other configurations without deviating from the teachings disclosed herein. By way of example, and not limitation, FIG. 2 depicts the calibration assessment system interacting with vehicle 100 (see FIG. 1), but other vehicles having other configurations may be subjected to calibration assessment by the calibration assessment system without deviating from the teachings disclosed herein.

The calibration assessment system comprises a system processor 201 and a system memory 203. System memory 203 may comprise computer-readable instructions stored thereon that, when read by system processor 201, cause system processor 201 to execute one or more functions. System memory 203 may additionally store specification data useful during calibration assessment, such as data describing proper calibration performance for sensors of varying sensor configurations, data describing proper calibration standards for varying vehicle configurations, data describing calibration procedures for sensors of varying configurations, and data describing assessment procedures for sensors of varying configurations. System memory 203 may store additional information without deviating from the teachings disclosed herein.

System memory 203 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

The system further comprises a system transmitter 209 operable to wirelessly send data signals to vehicle 100 and a system receiver 211 operable to wirelessly receive data signals from vehicle 100. Each of system transmitter 209 and system receiver 211 are in data communication with system processor 201. The wireless data signals may be exchanged with vehicle transmitter 109 and vehicle receiver 111 (see FIG. 1). In the depicted embodiment, system transmitter 209 and system receiver 211 are depicted as separate components of the system, but other embodiments may be configured as having a single transceiver element performing the functions of both without deviating from the teachings disclosed herein.

The system also comprises a calibration device 213 in data communication with system processor 201. Calibration device 213 operates as a reference for a sensor during assessment thereof. In the depicted embodiment, calibration device 213 may comprise a reflective target for an optical sensor, but other embodiments may comprise other devices utilized in other assessments without deviating from the teachings disclosed herein. In the depicted embodiment, calibration device 213 is depicted as situated in front of vehicle 100, but other embodiments may utilize other arrangements without deviating from the teachings disclosed herein. Some embodiments may comprise additional or different calibration devices 213 without deviating from the teachings disclosed herein. In the depicted embodiment, calibration device 213 may be configurable to accommodate different configurations specified for a particular calibration assessment. Other embodiments may comprise different configurability without deviating from the teachings disclosed herein.

The accuracy of the assessment may be impacted by the relative position of vehicle 100 to calibration device 213. In such embodiments, the relative position of vehicle 100 with respect to calibration device 213 may be measured by an activation sensor 215. In the depicted embodiment, activation sensor 215 may be operable to measure the position and orientation of vehicle 100 with respect to calibration sensor 213, and generate an initiation signal in response to vehicle 100 being in a position suitable for the calibration assessment, the initiation signal indicating to the system that vehicle 100 is in suitable position for an assessment operation. Upon receipt of the initiation signal, processor 201 may transmit an assessment-start signal to vehicle 100 that is operable to begin the calibration assessment functions of vehicle 100. Activation sensor 215 may be operable to measure the conditions within an activation zone 217, and generate the assessment-start signal in response to measurements indicating that vehicle 100 is appropriately positioned for calibration assessment. In the depicted embodiment, activation sensor 215 may comprise a proximity sensor, optical sensor, camera, or other sensor known to one of ordinary skill in the art without deviating from the teachings disclosed herein. Some embodiments may comprise a plurality of activation sensors 215 without deviating from the teachings disclosed herein. Some embodiments may comprise different arrangements of one or more activation sensors without deviating from the teachings disclosed herein.

The calibration assessment system may be embodied as part of an infrastructure supporting other vehicle functions. By way of example, and not limitation, the calibration assessment system of FIG. 2 may be embodied within a fueling station, weigh station, parking lot, parking structure, car wash, maintenance facility or other routine vehicle-related infrastructure without deviating from the teachings disclosed herein. In such infrastructure embodiments, the system may advantageously be utilized to perform a sensor calibration assessment during other routine functions of the vehicle or a technician working on the vehicle, thus improving the efficiency of service for the vehicle.

In some embodiments, calibration device 213 may comprise mobility functions such that the calibration device 213 may move with respect to vehicle 100. Movement of calibration device 213 may advantageously be operated autonomously, to permit vehicle 100 to be serviced by technicians or other functions of the infrastructure while the calibration assessment may be automatic. Different embodiments may have different configurations without deviating from the teachings disclosed herein. In some embodiments, calibration device 213 may be mobile for utilization during a calibration assessment to be performed by a moving vehicle, such as through an automated car wash or a controlled-speed highway toll tone.

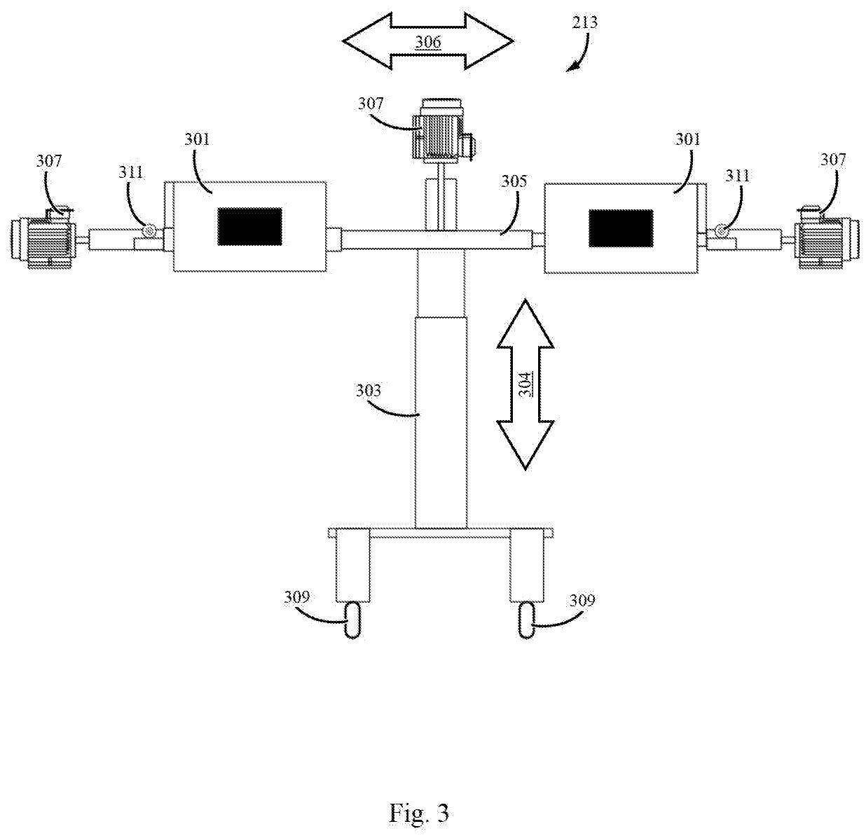

FIG. 3 is an illustration of one embodiment of a calibration device 213 according to the teachings disclosed herein. Calibration device 213 may comprise one or more autonomously-adjustable configuration elements. Other embodiments may comprise other configurations without deviating from the teachings disclosed herein. In the depicted embodiment, calibration device 213 may comprise a number of calibration targets 301 providing reflective surfaces during calibration of a sensor such as an optical sensor, radar sensor, lidar sensor, camera, ultraviolet sensor, ultrasonic sensor, or other similar sensor recognized by one of ordinary skill in the art. In the depicted embodiment, targets 301 have a 2-color design, but other configurations may comprise other designs specified according to the sensor under test. In some embodiments, targets 301 may comprise a configurable design without deviating from the teachings disclosed herein. Calibration device 213 may comprise an upright support 303 that has an adjustable height along an upright direction 304. Calibration device 213 may comprise a transverse support 305 that has an adjustable width along a transverse direction 306. Upright support 303 and transverse support 305 may be utilized to provide configurable support for targets 301. The adjustable nature of upright support 304 and transverse support 306 may be utilized to position each of targets 301 to specified positions with respect to a vehicle under assessment. In the depicted embodiment, each of targets 301 may be positioned along transverse direction 306 independently of each other, but other embodiments may comprise different configurations having different configurability without deviating from the teachings disclosed herein. In the depicted embodiment, the adjustment of upright support 303 and transverse support 305 may be accomplished by a number of electric motors 307. Electric motors 307 may be advantageously operated in an autonomous manner without direct input from a user or technician. Other embodiments may comprise other configurations having other adjustment mechanisms without deviating from the teachings disclosed herein. The configuration of calibration device 213 may be controlled via a processor in data communication with the device, such as system processor 201 (see FIG. 2).

The position of calibration device 213 may be adjusted by moving the device, or changing its orientation. In the depicted embodiment, calibration device 213 comprises a number of wheels 309 that may be utilized to make adjustments to the whole of its position. In the depicted embodiment, each of wheels 309 may comprise multi-directional casters, but other embodiments may comprise other configurations without deviating from the teachings disclosed herein. Motion of calibration device 213 may be achieved by a prime mover (not shown), such as an electric motor or engine operable to drive wheels 309. In the depicted embodiment, the wheels 309 may advantageously be autonomously operated, permitting calibration device 213 autonomous mobility without intervention from a user. Other embodiments may comprise other configurations without deviating from the teachings disclosed herein. The position and orientation of calibration device 213 may be controlled via a processor in data communication with the device, such as system processor 201 (see FIG. 2).

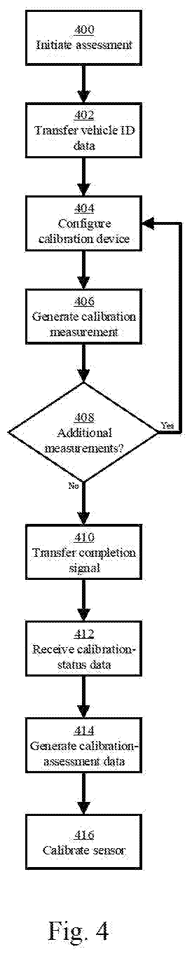

FIG. 4 is a flowchart showing steps of a method of calibration assessment of a vehicle sensor using a calibration assessment system, such as the system depicted in FIG. 2. The method begins at step 400 by initiating an assessment procedure, such as in response to a received initiation signal. In response, an assessment-start signal may be transmitted to the vehicle under assessment, placing the vehicle in an operating state suitable to perform the calibration assessment procedure with the assessment system. The method continues to step 402, where identification information describing the vehicle is transferred to the system, indicating to the system what steps are appropriate for a calibration assessment.

In response to identifying the vehicle with the identification information, the method continues to step 404, where an associated calibration device is autonomously configured to correspond to a configuration specified for a calibration measurement. The calibration measurement is generated at step 406, and the method continues to step 408 where it is determined if additional calibration measurements are specified for a specified assessment of the vehicle sensor based upon the sensor specification and the already-completed calibration measurements. If additional measurements are required, the method returns to step 404, where the calibration device may be configured, re-configured, or re-positioned to correspond to another calibration measurement. Steps 404-408 may be iterated for the number of measurements required for a specified assessment according to the specification of the sensor.

When no further measurements are required for a proper calibration assessment, the method proceeds to step 410, wherein the vehicle transfers a completion signal, indicating to the system that it has completed the measurement phase of the assessment. At step 412, the system receives calibration-status data indicating the measurement results of each of the measurements performed at step 406. In the depicted embodiment, step 412 occurs after the transfer of a completion signal, but some embodiments may transfer the calibration-status data after step 406 during the iterative measurement phase of the assessment without deviating from the teachings disclosed herein.

Upon receipt of the calibration-status data from the vehicle, the system then generates calibration-assessment data indicating the overall calibration status of the sensor at step 414. Calibration-assessment data may comprise a technical analysis, raw measurement data, or a human-readable summary of the calibration-status data. In some embodiments, the system may deliver the calibration-assessment data to a user, such as a technician performing diagnostics upon the vehicle subject to assessment. In such embodiments, the calibration-assessment data may comprise a summary of the results of the calibration assessment.

In some embodiments, the calibration-assessment data may be delivered to a device in data communication with the system, such as a tablet computer, smartphone, personal computer, or other device operable to receive and present the data known to one of ordinary skill in the art at the time without deviating from the teachings disclosed herein. In some embodiments, the calibration-assessment data may be delivered to an electronic account associated with the user, such as an e-mail address, text-capable phone number, proprietary messaging service profile, or any other data transmission method recognized by one of ordinary skill in the art without deviating from the teachings disclosed herein. In some embodiments, the user may comprise different parties associated with the vehicle or the system, such as an owner of the vehicle, a driver or passenger of the vehicle, a fleet manager associated with the vehicle in a commercial setting, a technician, or any other user associated with the vehicle recognized by one of ordinary skill without deviating from the teachings disclosed herein. Some embodiments may not deliver the calibration-assessment data without deviating from the teachings disclosed herein. Some embodiments may store the calibration-assessment data locally or on a remote memory without deviating from the teachings disclosed herein.

After the calibration-assessment data is generated, the method may move to step 416 wherein the vehicle is calibrated in response to the findings of the calibration-assessment data. Some embodiments may not comprise step 416 without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A calibration assessment system comprising:
a processor;
a system transmitter in data communication with the processor, the transmitter configured to transmit a wireless transmission to a vehicle subject to calibration assessment;
a system receiver in data communication with the processor, the receiver configured to receive a wireless transmission from a vehicle subject to calibration assessment;
an initiation-signal generator in data communication with the processor and configured to generate and transmit an initiation signal to the processor when a vehicle is in a specified position; and
a calibration device in data communication with the processor and having an autonomously-adjustable configuration;
wherein the system transmitter is further configured to transmit an assessment-start signal to a vehicle in response to the initiation-signal generator transmitting the initiation signal, wherein the system receiver is configured to receive vehicle identification data from the vehicle in response to receipt of the assessment-start signal, and wherein the calibration device is configured to autonomously-configure based upon the vehicle identification data.

2. The calibration assessment system of claim 1, further comprising:
a vehicle receiver associated with a vehicle operable to receive wireless transmissions from the system transmitter; and
a vehicle transmitter associated with the vehicle operable to transmit wireless transmission to the system receiver,
wherein the vehicle receiver and the vehicle transmitter are disposed at least partially within a specified proximity of the body of the vehicle.

3. The calibration assessment system of claim 2, wherein the vehicle receiver and vehicle transmitter are embodied within a dangle configured to interface with a diagnostic port of a vehicle.

4. The calibration assessment system of claim 1, wherein the specified position is defined with respect to the calibration device.

5. The calibration assessment system of claim 1, wherein the calibration device is suitable for use in an assessment of a vehicle sensor associated with operation of an autonomous function of the vehicle.

6. The calibration assessment system of claim 1, wherein the processor is configured to generate assessment instructions for a vehicle to perform a calibration assessment of a sensor associated with the vehicle, and wherein the system transmitter is operable to transmit the assessment instructions.

7. The calibration assessment system of claim 6, wherein the processor is configured to generate calibration instructions in response to a calibration assessment and the system transmitter is operable to transmit the calibration instructions, wherein the calibration instructions cause the vehicle to perform a calibration of the sensor.

8. The calibration assessment system of claim 1, wherein the calibration device is configured to be utilized during a calibration assessment operation while a vehicle under assessment is moving.

9. A method of assessing the calibration of a sensor of a vehicle, the method comprising:
receiving an initiation signal indicating the vehicle is in a specified position with respect to a calibration device having an autonomously-adjustable configuration;
transmitting an assessment-start signal to the vehicle, the assessment-start signal directing the vehicle to initiate a calibration-assessment operation associated with the sensor;
receiving an identification signal from the vehicle specifying identification data associated with the vehicle;
autonomously configuring the calibration device into a first configuration corresponding to the identification signal;
generating a first calibration measurement of the sensor using the first configuration;
receiving a completion signal from the vehicle indicating that the first calibration measurement has been completed;
receiving calibration-status data from the vehicle, indicating a condition of the sensor under calibration; and
generating calibration-assessment data indicating the calibration status of the sensor in response to receipt of the calibration-status data.

10. The method of claim 9, wherein after generating the first calibration measurement:
receiving an adjustment signal from the vehicle indicating completion of the first calibration measurement;
autonomously configuring the calibration device into a second configuration in response to receiving the adjustment signal; and
generating a second calibration measurement of the sensor using the second configuration.

11. The method of claim 10, wherein the steps of receiving the adjustment signal and autonomously configuring the calibration device in response to receiving the adjustment signal are iteratively repeated a number of times corresponding to a number of calibration conditions specified by the identification signal.

12. The method of claim 9, further comprising the step of generating a summary of the calibration-assessment data indicating the results of the calibration assessment, and transmitting to the summary to a receiving account affiliated with a user.

13. The method of claim 12, wherein the user is a technician.

14. The method of claim 12, wherein the receiving account comprises an email address.

15. The method of claim 9, wherein the calibration device is suitable for use in an assessment of a vehicle sensor associated with operation of an autonomous function of the vehicle.
